(19) United States
(12) Patent Application Publication
(10) Pub. No.: US 2026/0194965 A1
(43) Pub. Date: Jul. 9, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Daisuke WAKUDA, Kyoto (JP); Shinichi SHIKII, Nara (JP); Aki YONEDA, Hyogo (JP); Kenichiro NOSAKA, Osaka (JP); Mika SUNAGAWA, Osaka (JP); Koki TAKAHASHI, Osaka (JP)

(21) Appl. No.: 18/730,249

(22) PCT Filed: Dec. 5, 2022
(86) PCT No.: PCT/JP2022/044670

§ 371 Date: Jul. 18, 2024

(30) Foreign Application Priority Data
Jan. 25, 2022 (JP) 2022-009735

(51) Int. Cl. G06F 3/01; G06V 40/10

(52) U.S. Cl. CPC G06F 3/011; G06F 2203/011; G06V 40/10

(57) ABSTRACT

An information processing method includes: obtaining identification information for identifying a user; presenting content including a content event to the user; generating a substance that stimulates the user's sense of smell, at a timing of presenting the content event; and outputting correspondence information in which the identification information obtained, emotion information indicating an emotion of the user at the timing of presenting the content event, and substance information indicating the substance generated are associated with each other.

### CROSS-REFERENCE OF RELATED APPLICATIONS

This application is the U.S. National Phase under 35 U.S.C. § 371 of International Patent Application No. PCT/JP2022/044670, filed on Dec. 5, 2022, which in turn claims the benefit of Japanese Patent Application No. 2022-009735, filed on Jan. 25, 2022, the entire disclosure of which Applications are incorporated by reference herein.

### TECHNICAL FIELD

The present invention relates to an information processing method, an information processing system, and a recording medium.

### BACKGROUND ART

There is a technology related to a scent generation device that can induce a user's emotion or action by generating a scent based on information delivered to a mobile terminal (see Patent Literature (PTL) 1).

### CITATION LIST

### Patent Literature

[PTL 1]

Japanese Unexamined Patent Application Publication No. 2009-217641

### SUMMARY OF INVENTION

### Technical Problem

However, the scent generated by the foregoing technology is a scent predetermined by the system. In other words, the generated scent may not be a scent that the user has actually experienced (specifically, a scent that the user has actually perceived). It is commonly known that the generation of a scent is based on the generation of a substance (also referred to as an olfactory stimulant) that stimulates the user's sense of smell (i.e. olfaction).

Thus, the foregoing technology has a problem in that the user's emotion may be unable to be appropriately induced using an olfactory stimulant.

The present invention therefore provides an information processing method that contributes to inducing a user's emotion.

### Solution to Problem

An information processing method according to an aspect of the present invention is an information processing method including: obtaining identification information for identifying a user; presenting content including a content event to the user; generating a substance that stimulates the user's sense of smell, at a timing of presenting the content event; and outputting correspondence information in which the identification information obtained, emotion information indicating an emotion of the user at the timing of presenting the content event, and substance information indicating the substance generated are associated with each other.

These general and specific aspects may be implemented using a system, a device, an integrated circuit, a computer program, or a computer-readable recording medium such as CD-ROM, or any combination of a system, a device, an integrated circuit, a computer program, and a recording medium.

### Advantageous Effects of Invention

The information processing method according to the present invention can contribute to inducing a user's emotion.

### BRIEF DESCRIPTION OF DRAWINGS

FIG. 1 is an explanatory diagram illustrating a first usage situation of an information processing system in an embodiment.

FIG. 2 is an explanatory diagram illustrating a second usage situation of the information processing system in the embodiment.

FIG. 3 is a block diagram illustrating the functional structure of the information processing system in the embodiment.

FIG. 4 is an explanatory diagram illustrating a first example of correspondence between content events and emotion information in the embodiment.

FIG. 5 is an explanatory diagram illustrating a second example of correspondence between content events and emotion information in the embodiment.

FIG. 6 is an explanatory diagram illustrating a first example of correspondence information in the embodiment.

FIG. 7 is an explanatory diagram illustrating a second example of correspondence information in the embodiment.

FIG. 8 is an explanatory diagram illustrating an example of adaptation information in the embodiment.

FIG. 9 is a flowchart illustrating a first example of processing by the information processing system in the embodiment.

FIG. 10 is a flowchart illustrating a second example of processing by the information processing system in the embodiment.

FIG. 11 is a flowchart illustrating a third example of processing by the information processing system in the embodiment.

FIG. 12 is a diagram illustrating another example of the appearance of a terminal in the embodiment.

FIG. 13 is a block diagram illustrating another example of the functional structure of the information processing system in the embodiment.

### DESCRIPTION OF EMBODIMENTS

### Underlying Knowledge Forming Basis of the Present Disclosure

The present inventors have found the following problem with the technology related to a scent generation device described in the “Background Art” section.

With the technology related to a scent generation device that can induce a user's emotion or action by generating a scent based on information delivered to a mobile terminal (see PTL 1), a scent corresponding to content, which is predetermined by the system, is generated by the scent generation device and presented to the user.

However, the scent generated by this technology may not be a scent that the user has actually experienced (specifically, a scent that the user has actually perceived). Thus, this technology has a problem in that the user's emotion may be unable to be appropriately induced using an olfactory stimulant.

Human memories or emotions may be evoked in association with scents. This is considered to be because the human sense of smell is connected directly to the amygdala and hippocampus, the parts that process memories and emotions, without passing through the thalamus. This effect that human memories or emotions are evoked in association with scents is commonly known as the Proust effect. The Proust effect can be regarded as a phenomenon that, based on an unconscious association of a user's memory or emotion with a scent, the user, upon perceiving the scent, unconsciously recalls the memory or emotion associated with the scent.

There is a possibility that the Proust effect can be used to induce users'emotions. For example, when a user experiences a certain emotion while perceiving a scent, the scent and the emotion are unconsciously associated with each other for the user. Once such an association has been formed, the user, upon perceiving the scent, may unconsciously feel the emotion through the Proust effect. In other words, the user is unconsciously induced to the emotion.

Since the Proust effect is based on the past experiences of individual users, scents that effectively produce the Proust effect differ for each individual user.

In the case of inducing a user's emotions using the Proust effect, it is useful to manage scents that effectively produce the Proust effect in advance. Managing scents that effectively produce the Proust effect in advance can contribute to inducing the user's emotions using scents through the Proust effect.

The present invention provides an information processing method that contributes to inducing a user's emotion using a scent (more typically, olfactory stimulus).

The following will describe examples of an invention obtained from the disclosure of this specification, and the effects, etc. achieved by such invention.
(1) An information processing method including: obtaining identification information for identifying a user; presenting content including a content event to the user; generating a substance that stimulates the user's sense of smell, at a timing of presenting the content event; and outputting correspondence information in which the identification information obtained, emotion information indicating an emotion of the user at the timing of presenting the content event, and substance information indicating the substance generated are associated with each other.

According to this aspect, the correspondence information indicating the association between the emotion of the user presented with the content event and the olfactory stimulant that is the substance generated at the timing of presenting the content event is generated. The user is expected to experience the emotion while receiving the olfactory stimulus at the timing. Hence, the correspondence information indicates the formation of an unconscious association between the emotion and the olfactory stimulus in the user. The use of the correspondence information can contribute to causing the user to feel the emotion, i.e. inducing the emotion in the user, by giving the olfactory stimulus to the user based on the association formed in the user. The information processing method thus contributes to inducing the user's emotion.
(2) The information processing method according to (1), further including: executing an estimation process of estimating an emotion felt by the user at the timing, wherein the emotion information indicates the emotion estimated by the estimation process.

According to this aspect, the correspondence information is generated and output using the emotion estimated to be actually felt by the user presented with the content event based on the detail of the content event. The information processing method thus further contributes to inducing the user's emotion by utilizing the user's experience of actually feeling the emotion.
(3) The information processing method according to (2), wherein in the estimation process, the emotion felt by the user at the timing is estimated at least by executing a first emotion estimation process on an image of the user captured at the timing.

According to this aspect, the emotion of the user is estimated based on the image of the user, and the correspondence information is more easily generated using the estimated emotion. The information processing method thus further contributes to inducing the user's emotion by more appropriately estimating the emotion actually felt by the user.
(4) The information processing method according to (2) or (3), wherein in the estimation process, the emotion felt by the user at the timing of presenting the content event is estimated at least by executing a second emotion estimation process on vital data obtained from the user at the timing.

According to this aspect, the emotion of the user is estimated based on the vital data obtained from the user, and the correspondence information is more easily generated using the estimated emotion. The information processing method thus further contributes to inducing the user's emotion by more appropriately estimating the emotion actually felt by the user.
(5) The information processing method according to any one of (2) to (4), wherein in the estimation process, a type and intensity of the emotion felt by the user at the timing are estimated, and the identification information obtained, the type and intensity of the emotion indicated by the emotion information, and the substance information are associated with each other to generate the correspondence information.

According to this aspect, the correspondence information that includes the type and intensity of the emotion actually felt by the user presented with the content event is generated. The correspondence information indicates that an unconscious association between a specific emotion and a specific olfactory stimulus has been formed in the user, and further indicates the intensity of the association. The use of such correspondence information can further contribute to inducing the user's emotion. The information processing method thus further contributes to inducing the user's emotion.
(6) The information processing method according to (1), wherein the emotion information indicates an emotion predetermined according to the content event.

According to this aspect, the correspondence information is more easily generated using the emotion predetermined according to the content event. The information processing method thus contributes to inducing the user's emotion more easily.
(7) The information processing method according to (1), wherein the emotion information indicates a type and intensity of an emotion predetermined according to the content event.

According to this aspect, the correspondence information is more easily generated using the type and intensity of the emotion predetermined according to the content event. The information processing method thus contributes to inducing the user's emotion more easily.
(8) The information processing method according to any one of (1) to (7), wherein the emotion information includes one or more items of emotion information, and the information processing method further includes: generating, for each of the one or more items of emotion information, adaptation information including an adaptation degree that indicates a degree at which the user adapts to feel an emotion indicated by the item of emotion information as a result of the user's sense of smell being stimulated by the substance generated.

According to this aspect, an index indicating the degree at which the user adapts to feel the emotion as a result of the user's sense of smell being stimulated is obtained. This index helps adjusting how the substance is generated when inducing the user's emotion. The information processing method thus further contributes to inducing the user's emotion.
(9) The information processing method according to (8), further including: preferentially selecting an emotion with a lower adaptation degree from among a plurality of emotions, wherein information indicating the emotion selected is used as the emotion information to generate the correspondence information.

According to this aspect, the correspondence information is generated using an emotion with a relatively low adaptation degree, i.e. an emotion that the user does not adapt well (i.e. is not well accustomed) to feel as a result of the user's sense of smell being stimulated. This can contribute to strengthening an unconscious association between the emotion and the scent (more typically, olfactory stimulus) that are assumed to be relatively weakly associated with each other for the user. The information processing method thus further contributes to inducing the user's emotion.
(10) The information processing method according to (8), further including: preferentially selecting an emotion according to a priority order that is set, from among a plurality of emotions, wherein information indicating the emotion selected is used as the emotion information to generate the correspondence information.

According to this aspect, the correspondence information is generated using the emotion according to the priority order. This can contribute to strengthening the association with the emotion according to the priority order. The information processing method thus further contributes to inducing the user's emotion.
(11) The information processing method according to (10), wherein the priority order is a predetermined order, or an order of priorities of emotions to be used when inducing the user's emotion.

According to this aspect, the priority order is set easily, and the correspondence information is generated using the emotion according to the priority order. The information processing method thus further contributes to inducing the user's emotion.
(12) The information processing method according to (8) or (9), wherein the adaptation degree is higher when an intensity of the emotion felt by the user at the timing is higher or when an amount of the substance generated is larger.

According to this aspect, the adaptation degree can be set more easily based on the intensity of the emotion felt by the user or the amount of the substance generated. The information processing method thus contributes to inducing the user's emotion more easily.
(13) The information processing method according to (12), wherein the amount of the substance generated is larger when a total number of times the substance is generated is larger or when a frequency at which the substance is generated is higher.

According to this aspect, the amount of the substance generated can be set more easily. The information processing method thus contributes to inducing the user's emotion more easily.
(14) The information processing method according to any one of (1) to (13), wherein the user is a first user, the identification information is first identification information, and the information processing method further includes: obtaining second identification information for identifying a second user; determining induced emotion information indicating an emotion to which the second user is to be induced, when the second identification information obtained matches the first identification information; and generating the substance indicated by the substance information associated with the second identification information and the induced emotion information in the correspondence information.

According to this aspect, when the second user is the same as the first user for which the correspondence information is generated, generating the substance using the correspondence information contributes to inducing the second user's emotion based on the unconscious association between the emotion and the olfactory stimulus. The information processing method can thus induce the user's emotion based on the unconscious association between the emotion and the olfactory stimulus.
(15) The information processing method according to (14), further including: controlling the generating of the substance based on an emotion estimated by an estimation process of estimating an emotion felt by the second user.

According to this aspect, the generation of the substance is controlled based on the emotion felt by the second user. Hence, for example when there is little or no need to induce the emotion in the second user, the generation of the substance can be reduced or prohibited. The information processing method thus contributes to inducing the user's emotion more appropriately.
(16) The information processing method according to any one of (1) to (15), wherein the substance that stimulates the user's sense of smell is a substance that causes the user to perceive a scent associated with the substance.

According to this aspect, the substance that stimulates the sense of smell is generated to cause the user to perceive the scent. The information processing method thus contributes to inducing the emotion by causing the user to perceive the scent.
(17) An information processing system including: an identifier that obtains identification information for identifying a user; a content controller that performs control to present content including a content event to the user; a generation controller that performs control to generate a substance that stimulates the user's sense of smell, at a timing of presenting the content event; and an outputter that outputs correspondence information in which the identification information obtained, emotion information indicating an emotion of the user at the timing of presenting the content event, and substance information indicating the substance generated are associated with each other.

According to this aspect, the same advantageous effects as the foregoing information processing method are achieved.
(18) A non-transitory computer-readable recording medium having recorded thereon a program for causing a computer to execute the information processing method according to any one of (1) to (16).

According to this aspect, the same advantageous effects as the foregoing information processing method are achieved.

These general and specific aspects may be implemented using a system, a device, an integrated circuit, a computer program, or a computer-readable recording medium such as CD-ROM, or any combination of a system, a device, an integrated circuit, a computer program, and a recording medium.

An embodiment will be described in detail below, with reference to the drawings.

The embodiment described below shows a general or specific example. The numerical values, shapes, materials, structural elements, the arrangement and connection of the structural elements, steps, the processing order of the steps etc. shown in the following embodiment are mere examples, and do not limit the scope of the present invention. Of the structural elements in the embodiment described below, the structural elements not recited in any one of the independent claims representing the broadest concepts are described as optional structural elements.

### EMBODIMENT

This embodiment will describe an information processing method and an information processing system that contribute to inducing a user's emotion. The information processing method and the information processing system contribute to inducing the user's emotion by giving an olfactory stimulus to the user through the generation of an olfactory stimulant.

Here, an example will be described in which a substance that generates a scent to be perceived by the user is used as the olfactory stimulant. The olfactory stimulant is, however, not limited to such. Any olfactory stimulant that stimulates the user's olfactory receptor and is not perceived by the user as a scent or an olfactory stimulus may also be used.

The information processing method and the information processing system in this embodiment may be used in (1) a situation where the user is given an experience related to a scent and (2) a situation where the user's emotion is induced by the scent. Each situation will be described.
(1) Situation where user is given experience related to scent

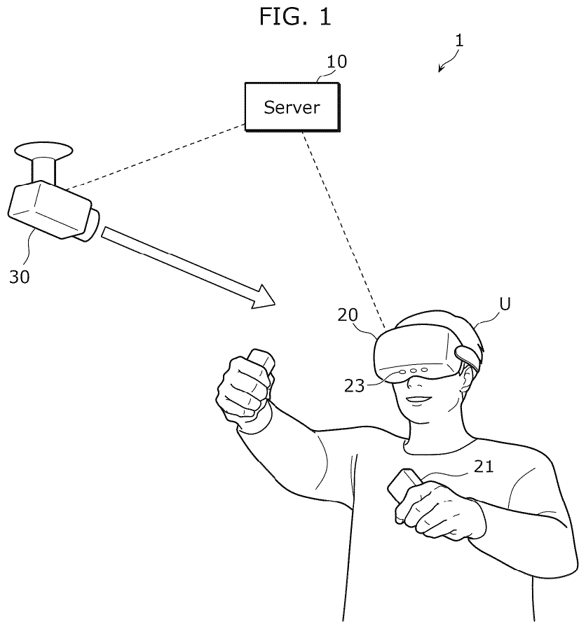

FIG. 1 is an explanatory diagram illustrating a first usage situation of information processing system 1 in this embodiment.

In FIG. 1, information processing system 1 causes user U to experience a content event to thus cause user U to feel an emotion and perceive a scent, thereby contributing to user U unconsciously associating the scent with the emotion. In this way, information processing system 1 creates a state in which the emotion is induced in user U based on the scent perceived by user U, that is, a state in which the Proust effect occurs in user U.

As illustrated in FIG. 1, information processing system 1 includes server 10 and terminal 20. Information processing system 1 may further include camera 30. The devices included in information processing system 1 are communicably connected to each other via a network.

Terminal 20 presents content and generates a scent. The presentation of the content and the generation of the scent by terminal 20 are performed under the control of server 10. The functions of terminal 20 will be described in detail later.

User U feels the emotion by viewing the content presented by terminal 20 and perceives the scent generated by terminal 20. In this way, information processing system 1 contributes to user U forming an unconscious association between the emotion and the scent.

For example, information processing system 1 contributes to user U forming an unconscious association between an emotion such as a sense of accomplishment or exhilaration and a specific scent.

Camera 30 is a camera that captures user U and generates an image of user U. The functions of camera 30 will be described in detail later.
(2) Situation where user's emotion is induced by scent

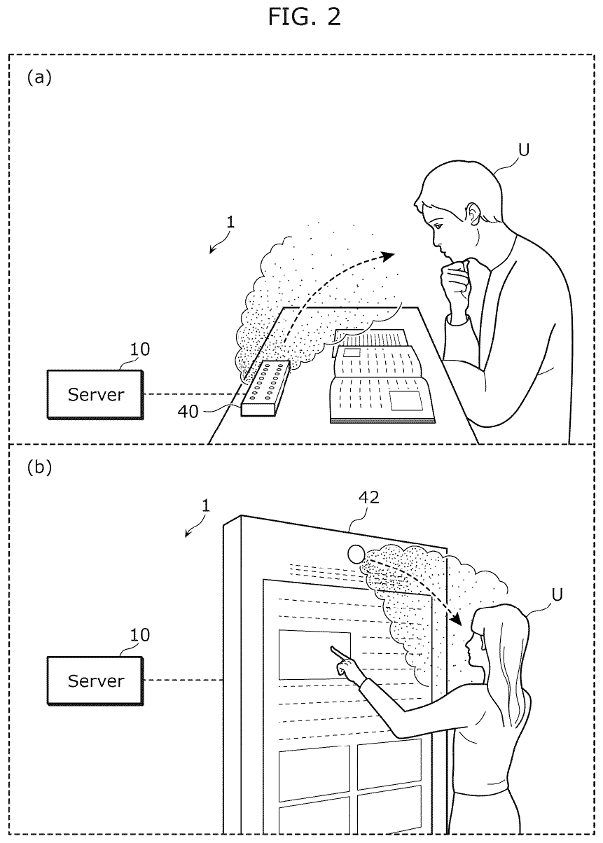

FIG. 2 is an explanatory diagram illustrating a second usage situation of information processing system 1 in this embodiment. Situation (2) illustrated in FIG. 2 is a situation after situation (1) above.

In FIG. 2, information processing system 1 presents the scent to induce user U to feel the emotion, by utilizing the unconscious association formed in user U in situation (1).

In (a) in FIG. 2, information processing system 1 includes server 10 and generation device 40. The devices included in information processing system 1 are communicably connected to each other via a network.

Generation device 40 generates a scent. The generation of the scent by generation device 40 is performed under the control of server 10. User U is expected to perceive the scent generated by generation device 40.

For example, generation device 40 presents the scent to cause (i.e. induce) user U to feel a sense of accomplishment or exhilaration while user U is studying, by utilizing the association formed in situation (1). This has the effect of improving study efficiency.

Generation device 40 may be terminal 20 in situation (1).

In (b) in FIG. 2, information processing system 1 includes server 10 and generation device 42. The devices included in information processing system 1 are communicably connected to each other via a network.

Generation device 42 generates a scent, as with generation device 40 in (a) in FIG. 2. The mechanism by which generation device 42 generates the scent is the same as that described for generation device 40. Generation device 42 is a digital signage device having a digital signage function. Generation device 42 includes a touch screen that receives input of operations by user U while presenting information to user U.

For example, generation device 40 presents the scent to cause (i.e. induce) user U to feel a sense of accomplishment or exhilaration while user U is viewing the information presented by generation device 42, by utilizing the association formed in situation (1). This has the effect of encouraging the user to take action (such as moving or purchasing).

Generation device 42 may be terminal 20 in situation (1).

The structure and functions of information processing system 1 will be described in detail below.

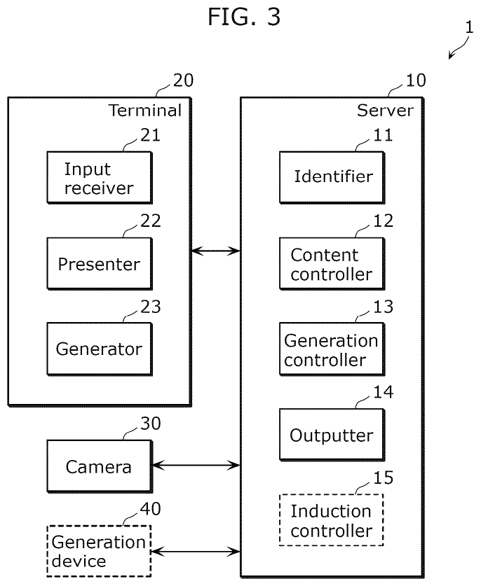

FIG. 3 is a block diagram illustrating the functional structure of information processing system 1 in this embodiment.

As illustrated in FIG. 3, information processing system 1 includes server 10, terminal 20, and generation device 40, and may further include camera 30. Generation device 40 may also serve as generator 23 in terminal 20, or may be implemented as one function in terminal 20. In this case, generation device 40 does not exist as an independent device.

Server 10 includes identifier 11, content controller 12, generation controller 13, outputter 14, and induction controller 15, as its functional units. The functional units included in server 10 can be implemented by a processor (for example, a central processing unit (CPU)) (not illustrated) in server 10 executing a program using memory (not illustrated). In situation (1), identifier 11, content controller 12, generation controller 13, and outputter 14 mainly function. In situation (2), induction controller 15 mainly functions.

Identifier 11 obtains identification information for identifying user U. Identifier 11 may obtain information input to input receiver 21 in terminal 20 and obtain the identification information from the information. The information input to input receiver 21 may be, for example, authentication information (more specifically, a user name and a password) for user U to log in to information processing system 1. Identifier 11 may obtain an image captured by camera 30 and obtain the identification information from the image. Identifier 11 may obtain the identification information of user U by identifying user U through well-known image analysis processing on the image captured by camera 30.

Content controller 12 performs control to present content including a content event to user U. The content is content that is presented over a period of time ranging from several seconds to several hours. The content is, for example, game content. This case will be described as an example. In this case, the content event may be levelling up a character in the game content, gaining bonus points by a character, or a character winning or losing a competitive game. Content controller 12 progresses the game content based on the input to input receiver 21 in terminal 20, and causes presenter 22 in terminal 20 to present the content including video or audio. Here, the content event included in the content is presented.

The content may be video content. In this case, the content event may be a specific scene in the video content (for example, a scene where the brightness or contrast of video is higher than a threshold, or a scene where a character succeeds or fails in a certain event).

The content may be audio content. In this case, the content event may be a specific part in music content (for example, a part in which the volume is higher than a threshold, an intro, a chorus, or an outro).

The content may be learning content. In this case, the content event may be an evaluation for a learning task (for example, an evaluation that the answer to the learning task is correct or incorrect).

Generation controller 13 performs control to generate a substance that stimulates user U's sense of smell at the timing of presenting the content event. The generation of a substance that stimulates user U's sense of smell is, more specifically, the generation of a substance that causes user U to perceive a scent, and can also be simply referred to as the generation of a scent. Generation controller 13 causes generator 23 in terminal 20 to generate the substance (more specifically, the scent). The scent is identified by a scent ID. The scent ID is an identifier that can uniquely identify the scent.

Outputter 14 outputs correspondence information. The correspondence information is information in which the obtained identification information, emotion information indicating the emotion of user U at the timing of presenting the content event, and substance information indicating the generated substance are associated with each other. The correspondence information may be predetermined, or may be generated by outputter 14 based on the control of generation controller 13 to generate the substance. In the case where the generation of a substance is the generation of a scent, substance information indicating the generated substance is scent information indicating the generated scent. This case will be described as an example.

The emotion information may be, for example, information indicating an emotion predetermined according to the content event. For example, an emotion of a sense of accomplishment or exhilaration may be predetermined for a content event of leveling up a character in game content.

The information indicating the emotion predetermined according to the content event may be information indicating the type and intensity of emotion predetermined according to the detail (also referred to as “factor”) of the content event. For example, an emotion of a sense of accomplishment or exhilaration may be predetermined for a content event of leveling up a character in game content, and also the intensity (for example, 2 or 4) of the emotion may be predetermined according to the increase (for example, +1 or +2) in level.

The emotion information may be, for example, information indicating an emotion estimated by an estimation process. The estimation process includes a process of estimating the emotion felt by the user at the timing of presenting the content event. In this case, outputter 14 may execute the estimation process and use, as the emotion information, information indicating the emotion of user U obtained as a result of the estimation process executed.

In the estimation process, the emotion of the user may be estimated at least by executing an emotion estimation process (corresponding to a first emotion estimation process) on an image of user U captured by camera 30 at the timing of presenting the content event. The first emotion estimation process can be implemented by well-known technology, for example, based on the position or shape of the user's facial feature (such as the mouth or eyes) shown in the image or the amount of change in the position or shape. For example, outputter 14 estimates that user U feels a positive emotion such as joy or excitement when the corners of the mouth of user U move upward more than usual, by the first emotion estimation process.

In the estimation process, the emotion felt by user U at the timing of presenting the content event may be estimated at least by executing an emotion estimation process (corresponding to a second emotion estimation process) on vital data obtained from user U at the timing of presenting the content event. The second emotion estimation process can be implemented by well-known technology, for example, based on vital data such as heart rate or blood pressure. For example, outputter 14 estimates that user U feels a positive emotion such as joy or excitement when vital data such as heart rate or blood pressure is high, by the second emotion estimation process.

In the estimation process, the type and intensity of emotion felt by user U at the timing of presenting the content event may be estimated. In this case, the correspondence information generated associates the obtained identification information, the type and intensity of emotion indicated by the emotion information, and the substance information with each other. For example, in the first emotion estimation process, the intensity of the emotion of joy or excitement can be estimated to be higher when the difference of the position of the corners of the mouth of the user from the usual time is greater. For example, in the second emotion estimation process, the intensity of the emotion of joy or excitement can be estimated to be higher when the difference of the heart rate or blood pressure of the user from the usual time is greater.

Outputter 14 may further generate adaptation information. The adaptation information includes an adaptation degree that indicates the degree at which user U adapts to feel the emotion indicated by the emotion information as a result of the user's sense of smell being stimulated by the substance generated (i.e. as a result of the user perceiving the scent). The adaptation degree may be higher when the intensity of the emotion felt by user U at the foregoing timing is higher or when the amount of the substance generated is larger. This is because, when the intensity of the emotion felt by user U is higher or when the amount of the substance generated is larger, the unconscious association between the scent and the emotion in user U is stronger. The amount of the substance generated may be larger when the number of times the substance is generated is larger or when the frequency at which the substance is generated is higher. The number of times the substance is generated or the frequency at which the substance is generated can be calculated from the correspondence information illustrated in FIG. 7.

In this case, content controller 12 may perform control to modify the content so as to increase the content events included in the content and present the modified content, based on the adaptation information. The modification of the content includes, for example, such a modification that lowers a threshold for leveling up in the game content to make leveling up easier. The modification of the content includes, for example, such a modification that makes user U's character defeat an opponent with a higher level than the user's character in the game content to thus strengthen the intensity of the emotion felt by user U. The modification of the content includes, for example, such a modification that presents many easy learning tasks to enhance the correct answer rate and increase the number of correct answer events.

For example, content controller 12 preferentially selects an emotion with a lower adaptation degree from among a plurality of predetermined emotions, and modifies the content so as to increase the number of content events associated with the selected emotion. Content controller 12 then presents the modified content, and generates the correspondence information using information indicating the selected emotion as the emotion information.

For example, content controller 12 preferentially selects an emotion according to a set priority order from among a plurality of predetermined emotions, and modifies the content so as to increase the number of content events associated with the selected emotion. Content controller 12 then presents the modified content, and generates the correspondence information using information indicating the selected emotion as the emotion information. The priority order may be a predetermined order, or an order of priorities of emotions to be used when inducing user U's emotion by a scent.

Induction controller 15 performs control to induce the user's emotion. Induction controller 15 determines whether the identification information (corresponding to second identification information) obtained by identifier 11 matches any of the identification information (corresponding to first identification information) already included in the correspondence information, and if they match, determines induced emotion information indicating an emotion to be induced in user U identified by the second identification information. Induction controller 15 then controls generator 23 to generate a substance indicated by substance information associated with the second identification information and the induced emotion information in the correspondence information. Induction controller 15 may control the generation of a substance based on an emotion estimated by an estimation process of estimating an emotion felt by user U identified by the second identification information. Specifically, in the case where the emotion estimated to be felt by user U is the same as the emotion to be induced in user U, induction controller 15 may perform control to reduce or prohibit the generation of the substance because there is little or no need to induce the emotion.

Terminal 20 includes input receiver 21, presenter 22, and generator 23.

Input receiver 21 receives input of operations by user U. Input receiver 21 includes sensors (an acceleration sensor, a touchpad, etc.) or buttons that receive operations by user U, and, upon receiving an operation by user U on any of the sensors or buttons, transmits the detail of the operation to server 10. The operations received by input receiver 21 include an operation of designating or selecting identification information for identifying the user. Input receiver 21 may also include sensors that obtain vital data (such as heart rate or blood pressure) of user U. Input receiver 21 transmits the obtained vital data to server 10. The vital data can be used in the process of estimating user U's emotion.

Presenter 22 presents content. Presenter 22 includes at least a display screen that displays images or a speaker that outputs sound, and presents content by displaying images or outputting sound. Presenter 22 presents content based on the control by content controller 12. The content presented by presenter 22 is, for example, content obtained from server 10. Presenter 22 receives, for example, instructions to start and end the presentation of the content or to control the progress of the content, and presents the content according to the instructions.

Generator 23 generates a scent. For example, generator 23 includes one or more predetermined scent cartridges, and generates a substance contained in the one or more scent cartridges into a space outside terminal 20 (i.e. releases the substance into the space) based on information received from server 10 to thus generate a scent.

Terminal 20 has a form that is worn on the head of user U (see FIG. 1), but is not limited to such. Terminal 20 may have a form of a digital signage device (see (b) in FIG. 2), or a form that includes a stationary display device, speaker, and scent generation device.

Camera 30 captures user U to obtain an image (still image or moving image) of user U, and transmits the image to server 10. The image can be used to obtain the identification information for identifying user U. The image can also be used to estimate the emotion felt by user U.

Generation device 40 is a device that generates a scent. Generation device 40 generates a scent under the control of server 10. The mechanism by which generation device 40 generates a scent is the same as that described for generator 23 in terminal 20.

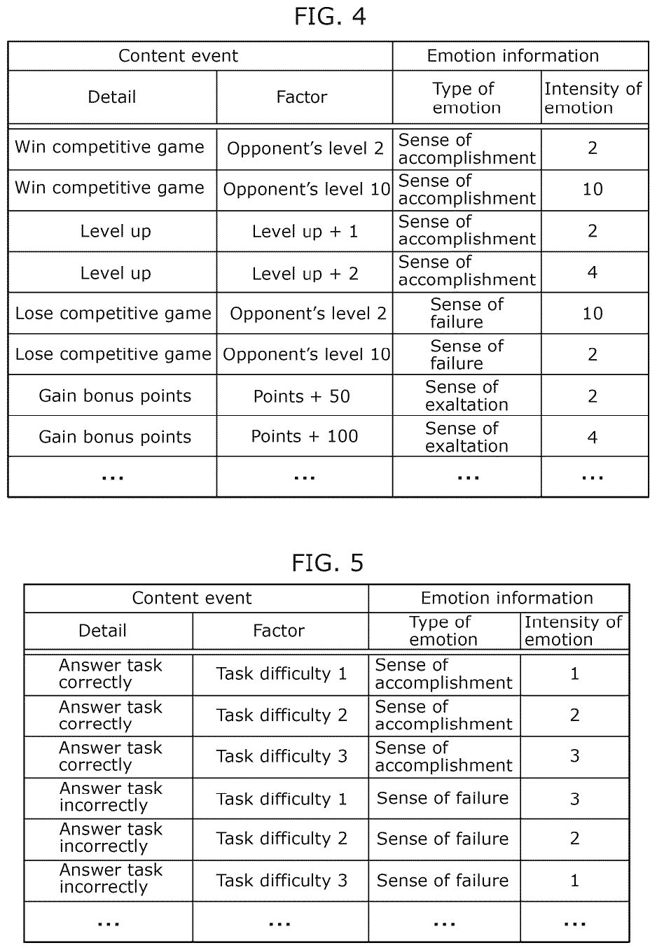

FIG. 4 is an explanatory diagram illustrating a first example of emotion information determined according to content events in this embodiment.

In the correspondence between content events and emotion information illustrated in FIG. 4, the details of each content event are subdivided into a plurality of factors and each factor is associated with an intensity of emotion.

For example, a content event of winning a competitive game is associated with an emotion of a sense of accomplishment. The opponent's levels are set as factors of the content event of winning a competitive game. Specifically, “opponent's level 2” is associated with emotion intensity “2”, and “opponent's level 10” is associated with emotion intensity “10”.

In detail, winning over an opponent with level 2 in a competitive game is associated with a sense of accomplishment with intensity 2. Winning over an opponent with level 10 in a competitive game is associated with a sense of accomplishment with intensity 10.

FIG. 5 is an explanatory diagram illustrating a second example of emotion information determined according to content events in this embodiment.

In the correspondence between content events and emotion information illustrated in FIG. 5, the details of each content event are subdivided into a plurality of factors and each factor is associated with an intensity of emotion, as in FIG. 4.

For example, a content event of answering a task correctly is associated with an emotion of a sense of accomplishment. Task difficulties are set as factors of the content event of answering a task correctly. Specifically, “task difficulty 1” is associated with emotion intensity “1”.

For example, a content event of answering a task incorrectly is associated with an emotion of a sense of failure. Task difficulties are set as factors of the content event of answering the task incorrectly. Specifically, “task difficulty 1” is associated with emotion intensity “3”.

In detail, answering a task with difficulty level 1 correctly is associated with a sense of accomplishment with intensity 1. Answering a task with difficulty level 1 incorrectly is associated with a sense of failure with intensity 3.

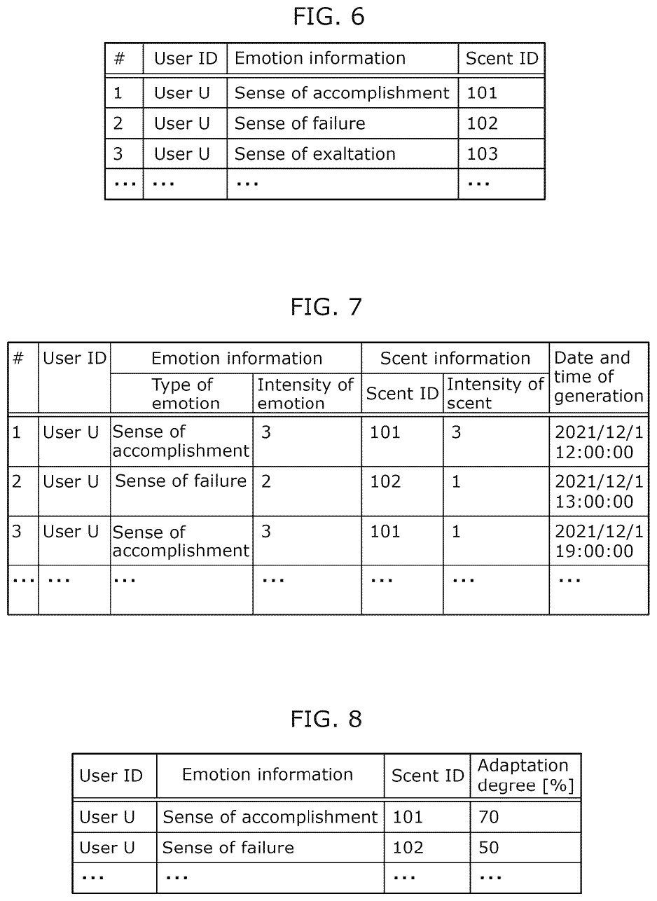

FIG. 6 is an explanatory diagram illustrating a first example of correspondence information in this embodiment.

The correspondence information illustrated in FIG. 6 is information in which a user ID as an example of identification information, emotion information, and a scent ID as an example of scent information are associated with each other. The identification information illustrated in FIG. 6 is predetermined information, and can be used when generation controller 13 identifies a scent the generation of which is to be controlled. Entries in the correspondence information may be set for each user and for each item of emotion information.

The correspondence information illustrated in FIG. 6 can be used, for example, for the purpose of forming, in the user identified by the user ID, an unconscious association between the emotion and the scent indicated in the correspondence information.

For example, entry #1 indicates that a scent with scent ID “101” is associated with an emotion of a sense of accomplishment in user U.

Entry #2 indicates that a scent with scent ID “102” is

associated with an emotion of a sense of failure in user U.

FIG. 7 is an explanatory diagram illustrating a second example of correspondence information in this embodiment.

The correspondence information illustrated in FIG. 7 is information in which a user ID as an example of identification information, emotion information, scent information, and a date and time of generation are associated with each other. The correspondence information illustrated in FIG. 7 may be information generated based on generation controller 13 performing control to generate a scent for user U. The emotion information includes the type and intensity of emotion. The scent information includes a scent ID and the intensity of scent.

The correspondence information illustrated in FIG. 7 can be used, for example, for the purpose of recording the result of causing the user identified by the user ID to experience the emotion and the scent indicated in the correspondence information in order to form an unconscious association between the emotion and the scent in the user.

For example, entry #1 indicates that the scent with scent ID “101” was generated at 12:00:00 on Jan. 1, 2021 when user U felt a sense of accomplishment. Entry #1 also indicates that the intensity of user U's sense of accomplishment at the time was 3 and the intensity of the scent generated was 3.

For example, entry #2 indicates that the scent with scent ID “102” was generated at 13:00:00 on Jan. 1, 2021 when user U felt a sense of failure. Entry #2 also indicates that the intensity of user U's sense of failure at the time was 2 and the intensity of the scent generated was 1.

FIG. 8 is an explanatory diagram illustrating an example of adaptation information in this embodiment.

The adaptation information illustrated in FIG. 8 is information in which a user ID as an example of identification information, emotion information, and scent information are associated with each other.

The adaptation information illustrated in FIG. 8 includes an adaptation degree as an index indicating the degree at which the user identified by the user ID adapts to be induced to the emotion as a result of perceiving the scent. The adaptation degree is managed for each user and for each scent.

In FIG. 8, the adaptation degree of user U being induced to an emotion of a sense of accomplishment as a result of perceiving the scent with scent ID “101” is 70%.

In FIG. 8, the adaptation degree of user U being induced to an emotion of a sense of failure as a result of perceiving the scent with scent ID “102” is 50%.

The adaptation degree can be calculated using the number of times the substance is generated or the frequency at which the substance is generated, which is calculated from the date and time information included in the correspondence information (see FIG. 7). The number of times the substance is generated is calculated as the number of times the substance is generated in a certain period of time (several hours to several days). The frequency at which the substance is generated is calculated by dividing the number of times by the length of the period of time.

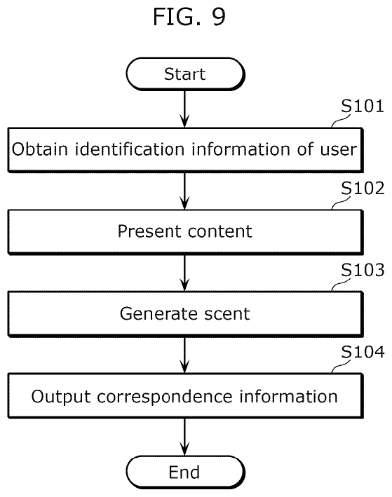

FIG. 9 is a flowchart illustrating a first example of processing by information processing system 1 in this embodiment. The processing illustrated in FIG. 9 represents a first example of an information processing method executed by information processing system 1 in situation (1).

In Step S101, identifier 11 obtains identification information of user U.

In Step S102, content controller 12 performs control to present content. Through this control, presenter 22 presents the content. The presented content is viewed by user U. When presenting the content, presenter 22 presents a content event included in the content.

In Step S103, generation controller 13 performs control to generate a scent. Through this control, generator 23 generates the scent. The generated scent is perceived by user U.

In Step S104, outputter 14 generates and outputs correspondence information in which the identification information obtained in Step S101, emotion information indicating user U's emotion at the timing of presenting the content event in Step S102, and substance information indicating the substance generated in Step S103 are associated with each other.

The series of processes illustrated in FIG. 9 contributes to inducing the user's emotion.

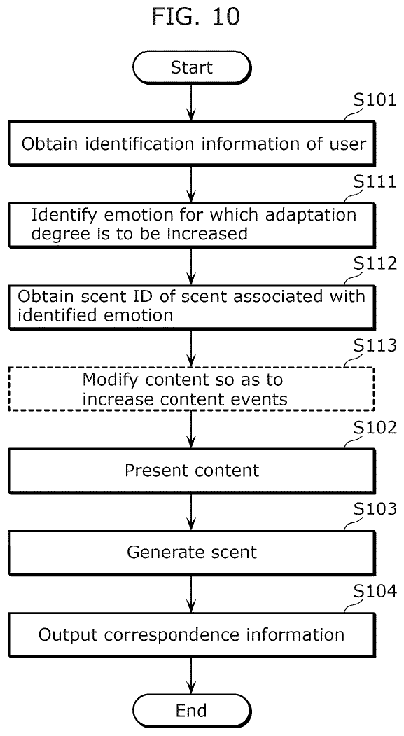

FIG. 10 is a flowchart illustrating a second example of processing by information processing system 1 in this embodiment. The processing illustrated in FIG. 10 represents a second example of the information processing method executed by information processing system 1 in situation (1).

It is assumed that the processing illustrated in FIG. 10 is executed in a state in which correspondence information has been generated as a result of executing the processing illustrated in FIG. 9 at least once. The same processes as those illustrated in FIG. 9 are given the same reference signs and their detailed description is omitted.

After identifier 11 obtains identification information in Step S101, in Step S111, content controller 12 identifies an emotion for which the adaptation degree is to be increased for user U identified by the obtained identification information. As the emotion for which the adaptation degree is to be increased, for example, an emotion with a relatively low adaptation degree may be preferentially selected from among the emotions indicated by the emotion information included in the correspondence information.

In Step S112, content controller 12 obtains the scent ID of the scent associated with the emotion information indicating the emotion identified in Step S111 in the correspondence information.

In Step S113, content controller 12 modifies the content so as to increase the content events included in the content.

After Step S113, server 10 uses the content modified in Step S113 to perform control to present the content and control to generate the scent at the timing of presenting the content event, and then generates and outputs correspondence information (Steps S102 to S103).

The series of processes illustrated in FIG. 10 contributes to inducing the user's emotion while preferentially strengthening the unconscious association between the emotion for which the adaptation degree is to be increased and the scent.

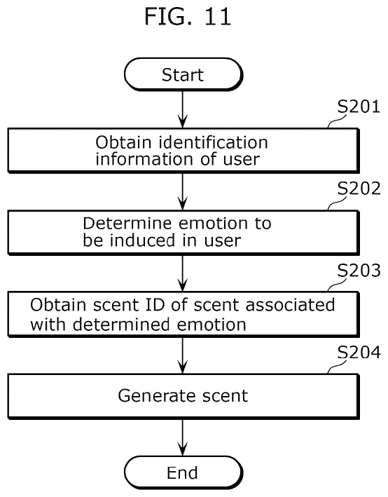

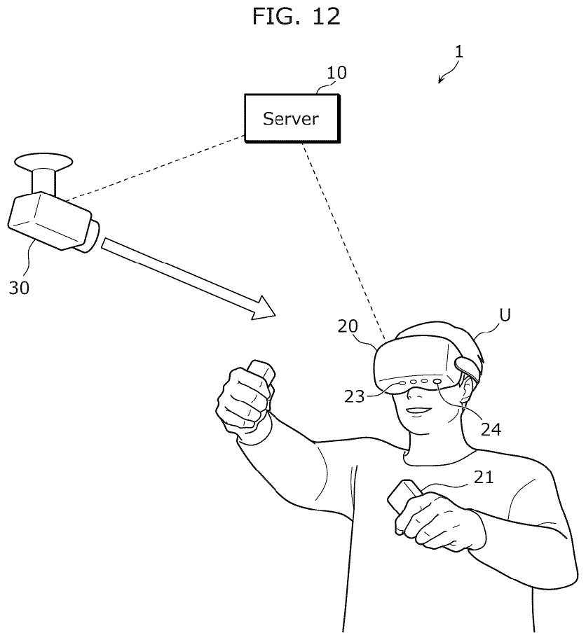

FIG. 11 is a flowchart illustrating a third example of processing by information processing system 1 in this embodiment. The processing illustrated in FIG. 11 represents an example of an information processing method executed by information processing system 1 in situation (2).

In Step S201, identifier 11 obtains identification information for identifying a user.

In Step S202, induction controller 15 determines an emotion to be induced in the user.

In Step S203, induction controller 15 obtains the scent ID of the scent associated with the emotion information indicating the emotion determined in Step S202 in the correspondence information.

In Step S204, generation controller 13 performs control to generate the scent indicated by the scent ID obtained in Step S203. Through this control, generation device 40 generates the scent. The generated scent is perceived by user U.

By the series of processes illustrated in FIG. 11, information processing system 1 contributes to inducing the emotion in user U by the scent.

Although the structure in which server 10 and terminal 20 are separate is described here, server 10 and terminal 20 may be configured as a single device (more specifically, configured as devices contained in one housing).

The above embodiment describes an example in which correspondence information is generated that associates one or both of the type and intensity of emotion of user U estimated by the emotion estimation process in outputter 14 with identification information and substance information. Here, the correspondence information may be generated using the scent around user U regardless of content events.

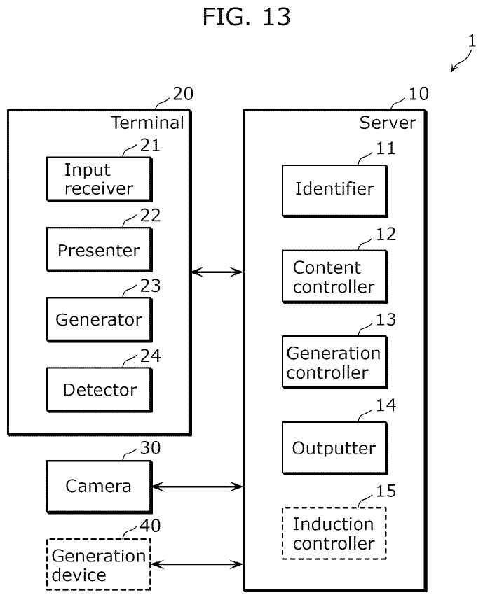

FIG. 12 a diagram illustrating another example of the appearance of the terminal in this embodiment. FIG. 13 is a block diagram illustrating another example of the functional structure of the information processing system in this embodiment.

In the example illustrated in FIG. 12, detector 24 is attached to the lower side of terminal 20 (i.e. the surface relatively close to user U's nostrils). Detector 24 can thus accurately detect the scent felt by user U. The position of detector 24 is not limited to the position illustrated in FIG. 12.

Outputter 14 may generate correspondence information including one or both of the type and intensity of emotion of user U and the scent information detected by detector 24 regardless of content events. Detector 24 is included in terminal 20 and is composed of, for example, a scent sensor, and quantifies the scent by analyzing the surrounding substance.

Hence, outputter 14 can generate correspondence information including one or both of the type and intensity of emotion of user U when some emotion arises in user U, regardless of content events. The correspondence information can be obtained efficiently in this way.

In one example, in the case where someone is cooking around user U and there is a good smell (scent) and user U strongly feels an emotion of hunger upon smelling the scent, the scent information, the emotion of hunger, and its intensity may be processed as correspondence information. In another example, a salty scent and a sense of exhilaration when user U is at the beach may be processed as correspondence information. Thus, embodiments are not limited. In this way, the personal relationship between the emotion and the scent obtained by user U can be processed as correspondence information, so that optimal information can be processed for each individual.

Terminal 20 may be a goggle type as illustrated in FIG. 1 or FIG. 12, or a see-through glasses type that allows user U to see ahead of terminal 20, and its form is not limited.

As described above, with the information processing method according to this embodiment, the correspondence information indicating the association between the emotion of the user presented with the content event and the olfactory stimulant that is the substance generated at the timing of presenting the content event is generated. The user is expected to experience the emotion while receiving the olfactory stimulus at the timing. Hence, the correspondence information indicates the formation of an unconscious association between the emotion and the olfactory stimulus in the user. The use of the correspondence information can contribute to causing the user to feel the emotion, i.e. inducing the emotion in the user, by giving the olfactory stimulus to the user based on the association formed in the user. The information processing method thus contributes to inducing the user's emotion.

With the information processing method, the correspondence information is generated and output using the emotion estimated to be actually felt by the user presented with the content event based on the detail of the content event. The information processing method thus further contributes to inducing the user's emotion by utilizing the user's experience of actually feeling the emotion.

With the information processing method, the emotion of the user is estimated based on the image of the user, and the correspondence information is more easily generated using the estimated emotion. The information processing method thus further contributes to inducing the user's emotion by more appropriately estimating the emotion actually felt by the user.

With the information processing method, the emotion of the user is estimated based on the vital data obtained from the user, and the correspondence information is more easily generated using the estimated emotion. The information processing method thus further contributes to inducing the user's emotion by more appropriately estimating the emotion actually felt by the user.

With the information processing method, the correspondence information that includes the type and intensity of the emotion actually felt by the user presented with the content event is generated. The correspondence information indicates that an unconscious association between a specific emotion and a specific olfactory stimulus has been formed in the user, and further indicates the intensity of the association. The use of such correspondence information can further contribute to inducing the user's emotion. The information processing method thus further contributes to inducing the user's emotion.

With the information processing method, the correspondence information is more easily generated using the emotion predetermined according to the content event. The information processing method thus contributes to inducing the user's emotion more easily.

With the information processing method, the correspondence information is more easily generated using the type and intensity of the emotion predetermined according to the content event. The information processing method thus contributes to inducing the user's emotion more easily.

With the information processing method, an index indicating the degree at which the user adapts to feel the emotion as a result of the user's sense of smell being stimulated is obtained. This index helps adjusting how the substance is generated when inducing the user's emotion. The information processing method thus further contributes to inducing the user's emotion.

With the information processing method, the correspondence information is generated using an emotion with a relatively low adaptation degree, i.e. an emotion that the user does not adapt well (i.e. is not well accustomed) to feel as a result of the user's sense of smell being stimulated. This can contribute to strengthening an unconscious association between the emotion and the scent (more typically, olfactory stimulus) that are assumed to be relatively weakly associated with each other for the user. The information processing method thus further contributes to inducing the user's emotion.

With the information processing method, the correspondence information is generated using the emotion according to the priority order. This can contribute to strengthening the association with the emotion according to the priority order. The information processing method thus further contributes to inducing the user's emotion.

With the information processing method, the priority order is set easily, and the correspondence information is generated using the emotion according to the priority order. The information processing method thus further contributes to inducing the user's emotion.

With the information processing method, the adaptation degree can be set more easily based on the intensity of the emotion felt by the user or the amount of the substance generated. The information processing method thus contributes to inducing the user's emotion more easily.

With the information processing method, the amount of the substance generated can be set more easily. The information processing method thus contributes to inducing the user's emotion more easily.

With the information processing method, when the second user is the same as the first user for which the correspondence information is generated, generating the substance using the correspondence information contributes to inducing the second user's emotion based on the unconscious association between the emotion and the olfactory stimulus. The information processing method can thus induce the user's emotion based on the unconscious association between the emotion and the olfactory stimulus.

With the information processing method, the generation of the substance is controlled based on the emotion felt by the second user. Hence, for example when there is little or no need to induce the emotion in the second user, the generation of the substance can be reduced or prohibited. The information processing method thus contributes to inducing the user's emotion more appropriately.

With the information processing method, the substance that stimulates the sense of smell is generated to cause the user to perceive the scent. The information processing method thus contributes to inducing the emotion by causing the user to perceive the scent.

Each of the structural elements in the foregoing embodiment may be configured in the form of an exclusive hardware product, or may be implemented by executing a software program suitable for the structural element. Each of the structural elements may be implemented by means of a program execution unit, such as a CPU and a processor, reading and executing the software program recorded on a recording medium such as a hard disk or semiconductor memory. Software for implementing the server etc. in the foregoing embodiment is the following program.

The program causes a computer to execute an information processing method including: obtaining identification information for identifying a user; presenting content including a content event to the user; generating a substance that stimulates the user's sense of smell, at a timing of presenting the content event; and outputting correspondence information in which the identification information obtained, emotion information indicating an emotion of the user at the timing of presenting the content event, and substance information indicating the substance generated are associated with each other.

While a server, etc. according to one or more aspects have been described above by way of embodiments, the present disclosure is not limited to such embodiments. Other modifications obtained by applying various changes conceivable by a person skilled in the art to the embodiments and any combinations of the structural elements in different embodiments without departing from the scope of the present disclosure are also included in the scope of one or more aspects.

### Industrial Applicability

The present invention can be used for an information processing device that executes information processing utilizing an unconscious association between memories or emotions and scents.

### REFERENCE SIGNS LIST

1 information processing system
10 server
11 identifier
12 content controller
13 generation controller
14 outputter
15 induction controller
20 terminal
21 input receiver
22 presenter
23 generator
24 detector
30 camera
40,42 generation device
U user

1. An information processing method comprising:
obtaining identification information for identifying a user;
presenting content including a content event to the user;
generating a substance that stimulates the user's sense of smell, at a timing of presenting the content event; and
outputting correspondence information in which the identification information obtained, emotion information indicating an emotion of the user at the timing of presenting the content event, and substance information indicating the substance generated are associated with each other.

2. The information processing method according to claim 1, further comprising:
executing an estimation process of estimating an emotion felt by the user at the timing,
wherein the emotion information indicates the emotion estimated by the estimation process.

3. The information processing method according to claim 2,
wherein in the estimation process, the emotion felt by the user at the timing is estimated at least by executing a first emotion estimation process on an image of the user captured at the timing.

4. The information processing method according to claim 2
wherein in the estimation process, the emotion felt by the user at the timing of presenting the content event is estimated at least by executing a second emotion estimation process on vital data obtained from the user at the timing.

5. The information processing method according to claim 2
wherein in the estimation process, a type and intensity of the emotion felt by the user at the timing are estimated, and
the identification information obtained, the type and intensity of the emotion indicated by the emotion information, and the substance information are associated with each other to generate the correspondence information.

6. The information processing method according to claim 1,
wherein the emotion information indicates an emotion predetermined according to the content event.

7. The information processing method according to claim 1,
wherein the emotion information indicates a type and intensity of an emotion predetermined according to the content event.

8. The information processing method according to claim 1,
wherein the emotion information includes one or more items of emotion information, and
the information processing method further comprises:
generating, for each of the one or more items of emotion information, adaptation information including an adaptation degree that indicates a degree at which the user adapts to feel an emotion indicated by the item of emotion information as a result of the user's sense of smell being stimulated by the substance generated.

9. The information processing method according to claim 8, further comprising:
preferentially selecting an emotion with a lower adaptation degree from among a plurality of emotions,
wherein information indicating the emotion selected is used as the emotion information to generate the correspondence information.

10. The information processing method according to claim 8, further comprising:
preferentially selecting an emotion according to a priority order that is set, from among a plurality of emotions,
wherein information indicating the emotion selected is used as the emotion information to generate the correspondence information.

11. The information processing method according to claim 10,
wherein the priority order is a predetermined order, or an order of priorities of emotions to be used when inducing the user's emotion.

12. The information processing method according to claim 8
wherein the adaptation degree is higher when an intensity of the emotion felt by the user at the timing is higher or when an amount of the substance generated is larger.

13. The information processing method according to claim 12,
wherein the amount of the substance generated is larger when a total number of times the substance is generated is larger or when a frequency at which the substance is generated is higher.

14. The information processing method according to claim 1,
wherein the user is a first user,
the identification information is first identification information, and
the information processing method further comprises:
obtaining second identification information for identifying a second user;
determining induced emotion information indicating an emotion to which the second user is to be induced, when the second identification information obtained matches the first identification information; and
generating the substance indicated by the substance information associated with the second identification information and the induced emotion information in the correspondence information.

15. The information processing method according to claim 14, further comprising:
controlling the generating of the substance based on an emotion estimated by an estimation process of estimating an emotion felt by the second user.

16. The information processing method according to claim 1,
wherein the substance that stimulates the user's sense of smell is a substance that causes the user to perceive a scent associated with the substance.

17. An information processing system comprising:
an identifier that obtains identification information for identifying a user;
a content controller that performs control to present content including a content event to the user;
a generation controller that performs control to generate a substance that stimulates the user's sense of smell, at a timing of presenting the content event; and
an outputter that outputs correspondence information in which the identification information obtained, emotion information indicating an emotion of the user at the timing of presenting the content event, and substance information indicating the substance generated are associated with each other.

18. A non-transitory computer-readable recording medium having recorded thereon a program for causing a computer to execute the information processing method according to claim 1.
